(19) United States
(12) Patent Application Publication
(10) Pub. No.: US 2010/0328285 A1
(43) Pub. Date: Dec. 30, 2010

(54) LIQUID CRYSTAL DISPLAY APPARATUS AND METHOD OF DRIVING LIQUID CRYSTAL DISPLAY APPARATUS

(75) Inventors: Werapong Jarupoonphol, Kanagawa (JP); Takeya Takeuchi, Aichi (JP); Tomohiko Sato, Kanagawa (JP)

Correspondence Address: SNR DENTON US LLP, P.O. BOX 061080, CHICAGO, IL, 60606-1080, US

(73) Assignee: SONY CORPORATION, Tokyo (JP)

(21) Appl. No.: 12/797,076

(22) Filed: Jun. 9, 2010

(30) Foreign Application Priority Data
Jun. 29, 2009 (JP) 2009-154276

(51) Int. Cl. G09G 3/36; G09G 5/00

(52) U.S. Cl. 345/209; 345/96

(57) ABSTRACT

A liquid crystal display apparatus includes a pixel array section having a plurality of scanning lines disposed in rows, a plurality of signal lines disposed in columns, a plurality of pixel circuits, a plurality of liquid crystal elements, and a plurality of common connection lines, and a drive circuit section having a scanning line drive circuit, a signal line drive circuit, and a common connection line drive circuit. The drive circuit section drives each of the pixel circuits so that a holding period in each frame period has a period during which a voltage of one liquid crystal element falls and a period during which the voltage rises.

### BACKGROUND OF THE INVENTION

1. Field of the Invention

The present invention relates to an active-matrix liquid crystal display apparatus and a method of driving the liquid crystal display apparatus.

2. Description of the Related Art

In recent years, liquid crystal display apparatuses for video display by driving display elements (liquid crystal elements) using liquid crystal have been widely utilized. In such a liquid crystal display apparatus, by changing an array of liquid crystal molecules in a liquid crystal layer sealed between substrates made of glass or the like, light from a light source is allowed to pass or is modulated for display.

With the advance of higher definition and higher luminance of display images, problems that had been less taken seriously have become apparent. Among these problems, one that particularly matters is an increase in display flicker and power consumption. One reason for worsened flicker is an increase of the influence of an electric current leaking from a pixel circuit owing to smaller pixel capacitance with higher definition. Another factor is an increase in luminance of a light source to make up for a decrease in luminance owing to a decrease in aperture ratio with higher definition. The increase in power consumption is attributed to, as described above, an increase in luminance of the light source to make up for a decrease in luminance owing to a decrease in aperture ratio.

### SUMMARY OF THE INVENTION

One way to suppress flicker is, for example, to improve the manufacturing process and the liquid crystal material. In this case, however, the manufacturing cost and prototype manufacturing period may be disadvantageously increased. Another way to suppress flicker is, for example, to drive at high speed (refer to Japanese Unexamined Patent Application Publication No. 2-83584). In this case, however, power consumption is disadvantageously further increased to impair the commercial value of the liquid crystal display apparatus.

It is desirable to provide a liquid crystal display apparatus and a method of driving the liquid crystal display apparatus capable of reducing flicker even without driving at high speed.

A liquid crystal display apparatus according to an embodiment of the present invention includes a pixel array section and a drive circuit section. The pixel array section has a plurality of scanning lines disposed in rows, a plurality of signal lines disposed in columns, and a plurality of pixel circuits disposed in a matrix correspondingly to intersections of the scanning lines and the signal lines and each connected to a relevant one of the scanning lines and a relevant one of the signal lines corresponding to a relevant one of the intersections. Furthermore, the pixel array section has a plurality of liquid crystal elements disposed in a matrix correspondingly to the intersections and each connected to a relevant one of the pixel circuits corresponding to the intersection, and a plurality of common connection lines connected to the plurality of liquid crystal elements for each row. The drive circuit section includes a scanning line drive circuit, a signal line drive circuit, and a common connection line drive circuit. The scanning line drive circuit is configured to sequentially apply a selection pulse to the plurality of scanning lines and sequentially select the liquid crystal elements for each of the scanning lines. The signal line drive circuit applies a signal voltage corresponding to a video signal to each of the signal lines so that a polarity is inverted for each frame period to perform writing in the selected liquid crystal elements. The common connection line drive circuit is configured to apply, during a write period in which writing in the selected liquid crystal elements is being performed, a voltage whose polarity is opposite to a polarity of the signal line to the common connection line corresponding to the selected liquid crystal elements. Here, the drive circuit section drives each of the pixel circuits so that a holding period in each frame period has a period during which a voltage of one liquid crystal element falls and a period during which the voltage rises.

A method of driving the liquid crystal display apparatus includes the step of, in a liquid crystal display apparatus including the pixel array section and a drive circuit section having the scanning line drive circuit, the signal line drive circuit, and the common connection line drive circuit, driving each of the pixel circuits by using the drive circuit section so that a holding period in each frame period has a period during which a voltage of one liquid crystal element falls and a period during which the voltage rises.

In the liquid crystal display apparatus and the method or driving the liquid crystal display apparatus according to an embodiment of the present invention, the pixel circuit is driven by the drive circuit section so that the holding period in each frame period has a period during which the voltage of one liquid crystal element falls and a period during which the voltage rises. With this, when the holding period is divided into a plurality of periods, average values of voltages to be applied to the liquid crystal elements can be equalized among the periods obtained through division.

Here, in the liquid crystal display apparatus and the method of driving the liquid crystal display apparatus according to an embodiment of the present invention, the common connection line drive circuit can perform driving described below, for example. That is, the common connection line drive circuit may apply voltages of a plurality of types to the plurality of common connection lines during the holding period in a predetermined frame period so that the holding period in each frame period has a period during which the voltage of one liquid crystal element falls and a period during which the voltage rises. In this case, average values of voltages to be applied to the liquid crystal elements can be equalized among all periods during which each voltage is applied.

According to the liquid crystal display apparatus and the method of driving the liquid crystal display apparatus in an embodiment of the present invention, when the holding period is divided into a plurality of periods, average values of voltages to be applied to the liquid crystal elements are equalized among periods obtained through division. With this, flicker can be reduced even without driving at high speed. Also, by driving at low speed as long as the flicker level satisfies specifications, power consumption can further be decreased.

### BRIEF DESCRIPTION OF THE DRAWINGS

FIG. 1 is a schematic diagram of structure of a liquid crystal display apparatus according to an embodiment of the present invention;

FIG. 2 is a diagram of structure of a sub-pixel in FIG. 1;

FIG. 3 is a waveform diagram illustrating an example of operation of the liquid crystal display apparatus in FIG. 1;

FIG. 4 is a schematic diagram illustrating an example of operation of the liquid crystal display apparatus in FIG. 1;

FIG. 5 is a schematic diagram illustrating the operation continued from FIG. 4;

FIG. 6 is a schematic diagram illustrating the operation continued from FIG. 5;

FIG. 7 is a schematic diagram illustrating another example of operation of the liquid crystal display apparatus in FIG. 1;

FIG. 8 illustrates what is depicted in the waveform diagram in FIG. 3 as a state diagram;

FIG. 9 is a state diagram illustrating a first modification example of operation of the liquid crystal display apparatus in FIG. 1;

FIG. 10 is a state diagram illustrating a second modification example of operation of the liquid crystal display apparatus in FIG. 1;

FIG. 11 is a state diagram illustrating a third modification example of operation of the liquid crystal display apparatus in FIG. 1;

FIG. 12 is a state diagram illustrating a fourth modification example of operation of the liquid crystal display apparatus in FIG. 1;

FIG. 13 is a state diagram illustrating a fifth modification example of operation of the liquid crystal display apparatus in FIG. 1;

FIG. 14 is a state diagram illustrating a sixth modification example of operation of the liquid crystal display apparatus in FIG. 1;

FIG. 15 is a state diagram illustrating a seventh modification example of operation of the liquid crystal display apparatus in FIG. 1;

FIG. 16 is a waveform diagram illustrating an eighth modification example of operation of the liquid crystal display apparatus in FIG. 1;

FIG. 17 is a state diagram illustrating a ninth modification example of operation of the liquid crystal display apparatus in FIG. 1;

FIG. 18 illustrates details of the state diagram in FIG. 17;

FIG. 19 is a diagram of structure illustrating an example of a common connection line drive circuit in FIG. 1;

FIG. 20 is a diagram of structure illustrating a first modification example of the common connection line drive circuit in FIG. 1;

FIG. 21 is a diagram of structure illustrating a second modification example of the common connection line drive circuit in FIG. 1;

FIGS. 22A and 22B are conceptual diagrams each for illustrating a leak current in the sub-pixel in FIG. 1;

FIGS. 23A and 23B are conceptual diagrams each for illustrating a leak current in the sub-pixel in FIG. 1;

FIG. 24 is a waveform diagram illustrating an example of operation of a liquid crystal display apparatus according to a comparison example;

FIGS. 25A and 25B are waveform diagrams each for illustrating a voltage to be applied to a liquid crystal element in the liquid crystal display apparatus according to the comparison example;

FIGS. 26A and 26B are waveform diagrams each for illustrating a voltage to be applied to a liquid crystal element in the liquid crystal display apparatus in FIG. 1;

FIG. 27 is a schematic diagram of structure of a liquid crystal display apparatus according to another embodiment of the present invention;

FIG. 28 is a diagram of structure of a sub-pixel in FIG. 27;

FIG. 29 is a waveform diagram illustrating an example of operation of the liquid crystal display apparatus in FIG. 27; and

FIG. 30 is a schematic diagram illustrating an example of operation of the liquid crystal display apparatus in FIG. 27.

### DESCRIPTION OF THE PREFERRED EMBODIMENTS

Embodiments of the present invention are described in detail below with reference to the drawings in the following order.

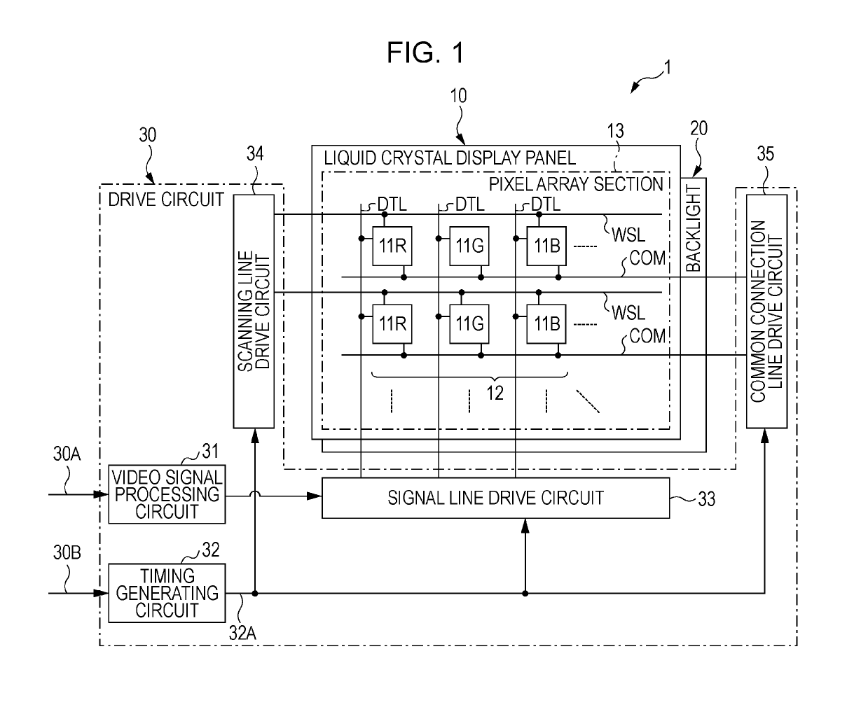

1. Embodiment (FIGS. 1 to 26)
An example in which no control line is connected to a middle node

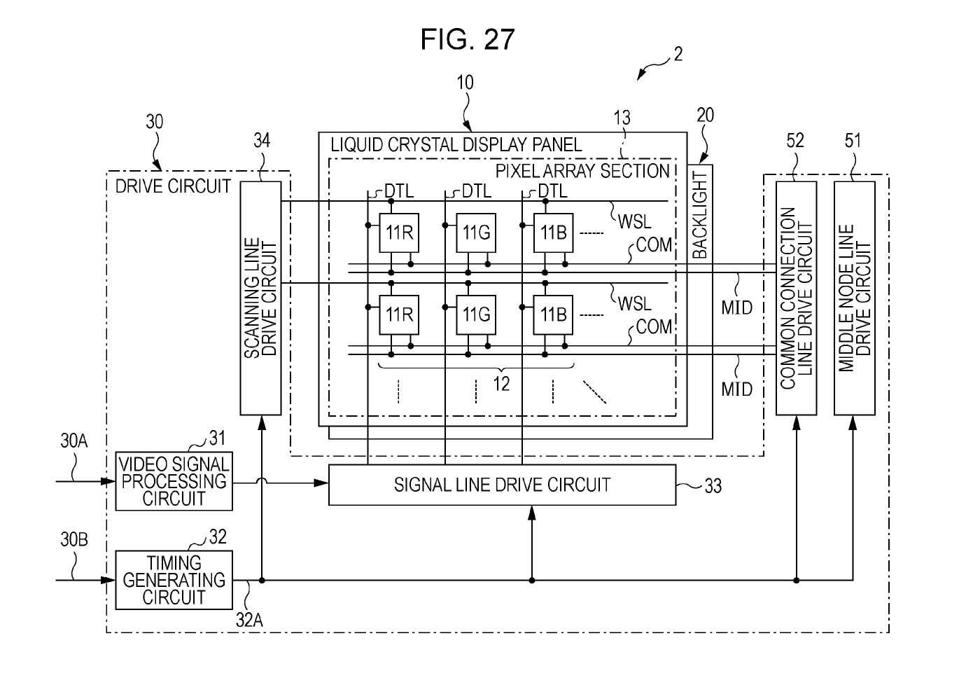

2. Another Embodiment (FIGS. 27 to 30)
An example in which a control line is connected to a middle node

### Embodiment

### Schematic Structure

FIG. 1 illustrates a schematic structure of a liquid crystal display apparatus 1 according to an embodiment of the present invention. The liquid crystal display apparatus 1 includes a liquid crystal display panel 10, a backlight 20 disposed at the rear of the liquid crystal display panel 10, and a drive circuit 30 that drives the liquid crystal display panel 10. The liquid crystal display panel 10 has, for example, a pixel array section 13 in which a plurality of sub-pixels 11R, 11G, and 11B are disposed in a matrix. In the present embodiment, for example, sub-pixels 11R, 11G, and 11B that are adjacent to each other form one pixel 12. Here, the sub-pixels 11R, 11G, and 11B are collectively referred to below as a sub-pixel 11 as appropriate. The drive circuit 30 has, for example, a video signal processing circuit 31, a timing generating circuit 32, a signal line drive circuit 33, a scanning line drive circuit 34, and a common connection line drive circuit 35.

### Pixel Array Section 13

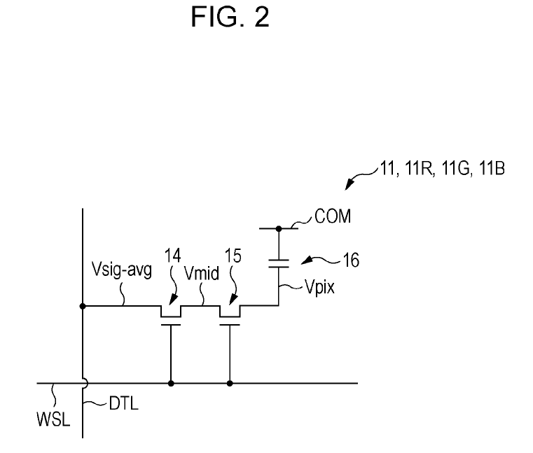

FIG. 2 illustrates an example of circuit structure in the pixel array section 13. As depicted in FIGS. 1 and 2, the pixel array section 13 has, for example, a plurality of scanning lines WSL disposed in rows and a plurality of signal lines DTL disposed in columns. Corresponding to intersections of the respective scanning lines WSL and signal lines DTL, the plurality of sub-pixels 11R, 11G, and 11B are disposed in a matrix. The pixel array section 13 further has a plurality of common connection lines COM, each corresponding to the sub-pixels 11R, 11G, and 11B for each row.

For example, as depicted in FIG. 2, each sub-pixel 11 has two transistors 14 and 15 and a liquid crystal element 16. Here, two transistors 14 and 15 correspond to a specific example of a “pixel circuit” in an embodiment of the present invention. For example, on a drive substrate, the liquid crystal element 16 has a common electrode, an insulating film, a pixel electrode, an alignment film, a liquid crystal layer, an alignment film, and a transparent substrate in this order from a drive substrate side. The drive substrate has, for example, the transistors 14 and 15 and other components formed on a glass substrate. The common electrode is a band-shaped electrode provided for each horizontal line (one row), and is commonly used by the liquid crystal elements 16 included in the plurality of sub-pixels 11 that belong to one horizontal line. This common electrode forms, for example, a part of the common connection line COM, and is electrically connected to the common connection line COM. The insulating film insulates and separates the common electrode and the pixel electrode from each other, and provides a space between the common electrode and the pixel electrode in a height direction. The liquid crystal layer is formed of liquid crystal in a vertical alignment (VA) mode or an in-plane switching (IPS) mode, and has a function of, with an applied voltage, transmitting or intercepting light emitted from the backlight 20. The pixel electrode functions as an electrode for each sub-pixel 11 and, for example, is disposed in a region not facing the common electrode. With this, when a voltage is applied between the pixel electrode and the common electrode, an electric field occurs in a lateral direction in the liquid crystal layer. The transistors 14 and 15 are, for example, field-effect thin film transistors (TFTs), and are each formed of a gate that controls a channel and a source and a drain provided at the ends of the channel. The transistors 14 and 15 may be p-type transistors or n-type transistors.

One end of the liquid crystal element 16 is connected to the source or drain of the transistor 15, and the other end of the liquid crystal element 16 is connected to the common connection line COM. The gates of the transistors 14 and 15 are connected to the scanning line WSL, and one of the source and drain of the transistor 15 that is not connected to the liquid crystal element 16 is connected to the source or drain of the transistor 14. One of the source and drain of the transistor 14 that is not connected to the transistor 15 is connected to the signal line DTL. Here, in the plurality of sub-pixels 11 that belong to one horizontal line, for example, the gates of the transistors 14 and 15 are connected to the common scanning line WSL. That is, the plurality of sub-pixels 11 connected to one scanning line WSL are disposed in a row along the one scanning line WSL.

Here, although not shown, in one horizontal line, for example, the gates of the transistors 14 and 15 of one sub-pixel 11 may be connected to one of two scanning lines WSL provided on both sides of each sub-pixel 11, and the gates of the transistors 14 and 15 of another sub-pixel 11 may be connected to the other one of the two scanning lines WSL provided on both sides of each sub-pixel 11. In this case, the plurality of sub-pixels 11 connected to one scanning line WSL may be disposed alternately (in a zigzag manner) across the one scanning line WSL. In this case, among the plurality of liquid crystal elements 16, liquid crystal elements 16 to be selected with the one scanning line WSL are disposed alternately across the one scanning line WSL.

### Backlight 20

The backlight 20 illuminates the liquid crystal display panel 10 from the back and, for example, includes a light guiding plate, a light source disposed on a side surface of the light guiding plate, and an optical element disposed on an upper surface (light emitting surface) of the light guiding plate. The light guiding plate guides light from the light source onto the upper surface of the light guiding plate. For example, the light guiding plate has a predetermined patterned shape on at least one of the upper and lower surfaces, and has a function of scattering and equalizing light incident from the side surface. The light source is a line-shaped light source, and is formed of, for example, a hot cathode fluorescent lamp (HCFL), a cold cathode fluorescent lamp (CCFL), or a plurality of light emitting diodes (LEDs) disposed in a line. The optical element is configured by, for example, laminating a diffusing plate, a diffusing sheet, a lens film, a polarizing and separating sheet, and others. Here, the backlight 20 may be of a direct-light type in which a diffusing plate and other optical elements are provided immediately above the light source.

### Drive Circuit 30

Next, each circuit in the drive circuit 30 provided around the pixel array section 13 is described with reference to FIG. 1.

The video signal processing circuit 31 corrects an externally-input digital video signal 30A and converts the corrected video signal to analog for output to the signal line drive circuit 33. The timing generating circuit 32 controls the signal line drive circuit 33, the scanning line drive circuit 34, and the common connection line drive circuit 35 so that these circuits operate in an interlocked manner. For example, the timing generating circuit 32 outputs a control signal 32A to these circuits in accordance (synchronization) with an externally-input synchronizing signal 30B.

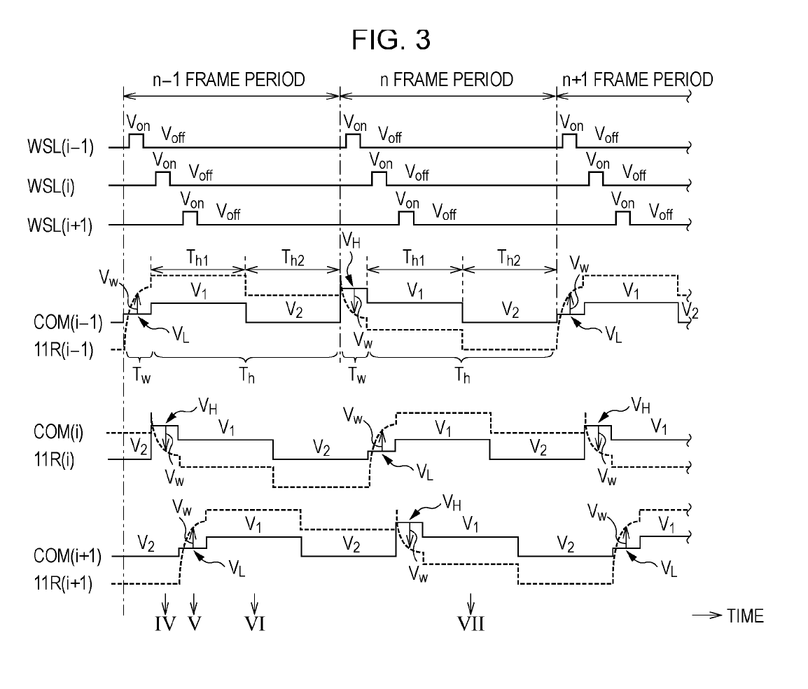

The signal line drive circuit 33 applies an analog video signal input from the video signal processing circuit 31 (a signal voltage corresponding to the video signal 30A) to each signal line DTL for writing in selected sub-pixels 11. For example, the signal line drive circuit 33 can output a signal voltage V_{sig} corresponding to the video signal 30A. For example, as depicted in FIGS. 3, 6, and 7, which will be described further below, the signal line drive circuit 33 can perform frame inversion driving of applying, to each signal line DTL, a signal voltage V_{sig} whose polarity is inverted for each frame period in relation to a reference voltage V_{ref} for writing in the selected sub-pixels 11. Frame inversion driving is to suppress deterioration of the liquid crystal element 16, and is used as appropriate. Furthermore, for example, as depicted in FIGS. 3 to 6, which will be described further below, the signal line drive circuit 33 can also perform 1H inversion driving of applying, to each signal line DTL, a signal voltage V_{sig} whose polarity is inverted for each 1H period in relation to the reference voltage V_{ref} to write the voltage corresponding to the signal voltage V_{sig} in the selected sub-pixels 11. 1H inversion driving is to suppress flicker from occurring for each frame owing to the inversion of the polarity of the voltage to be applied to the liquid crystal element 16, and is used as appropriate. Here, for example, the reference voltage V_{ref} is assumed to have 0 (zero) volt.

The scanning line drive circuit 34 applies a selection pulse to a plurality of scanning lines in accordance (synchronization) with an input of the control signal 32A to select a desired unit of a plurality of sub-pixels 11. As a unit of selecting the sub-pixels 11, for example, various units can be selected as appropriate, such as one line or adjacent two lines. Also, line selection can be sequential selection or random selection. For example, the scanning line drive circuit 34 can output a voltage Vₒₙ to be applied when the transistor 15 is turned on and a voltage V_{off} to be applied when the transistor 15 is turned off. Here, the voltage Vₒₙ has a value (a constant value) equal to or higher than an ON voltage of the transistor 15. The voltage V_{off} has a value (a constant value) lower than the ON voltage of the transistor 15.

Next, the common connection line drive circuit 35 is described. FIG. 3 is a timing diagram illustrating an example of operation of the liquid crystal display apparatus 1. In FIG. 3, waveforms in an n−1 frame period, an n frame period, and an n+1 frame period are illustrated. Here, in FIG. 3, to distinguish individual scanning lines WSL, common connection lines COM, and sub-pixels 11R, (i) (1≦i) is added to the end. Also, in FIG. 3, signal waveforms in sub-pixels 11G and 11B are omitted.

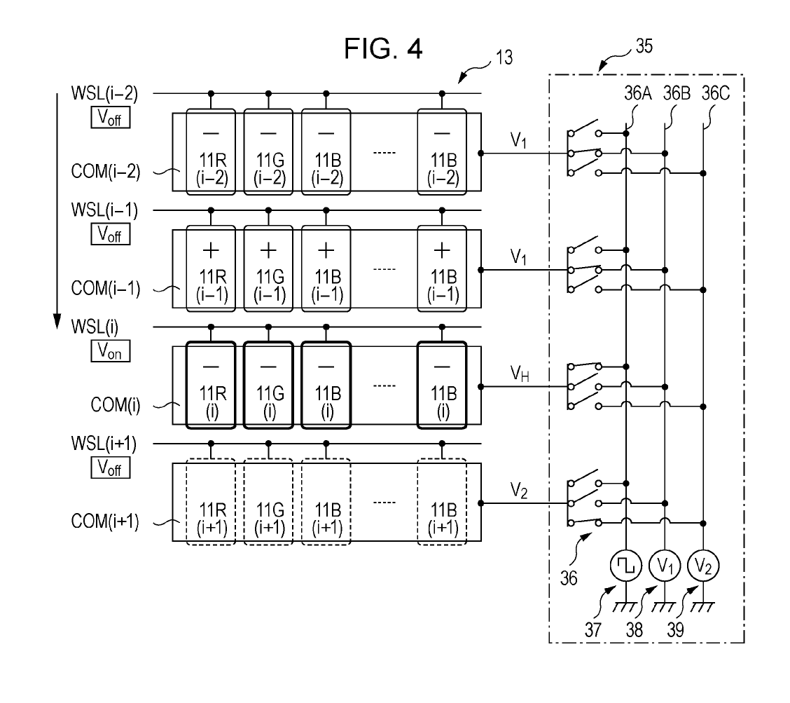

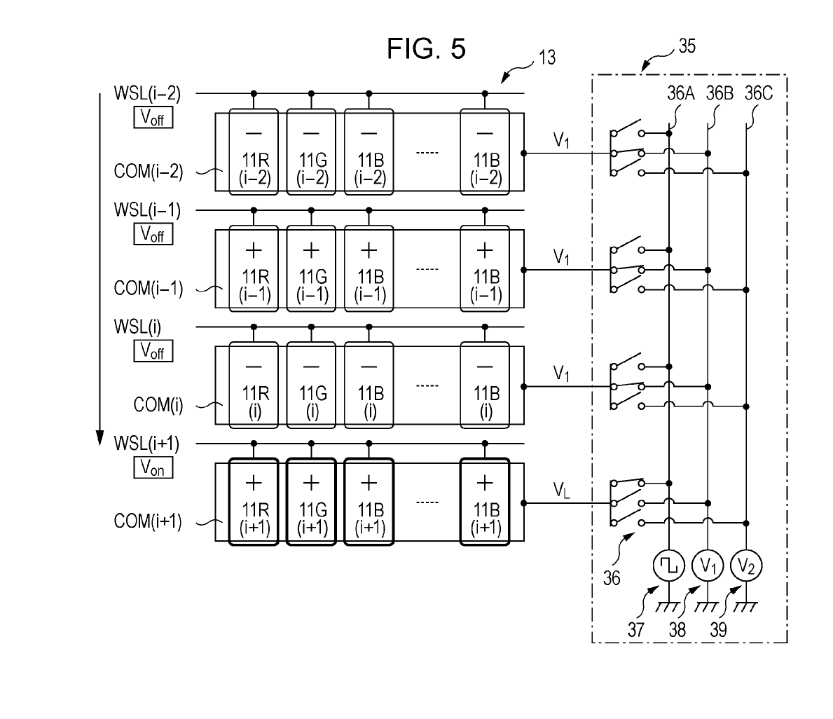

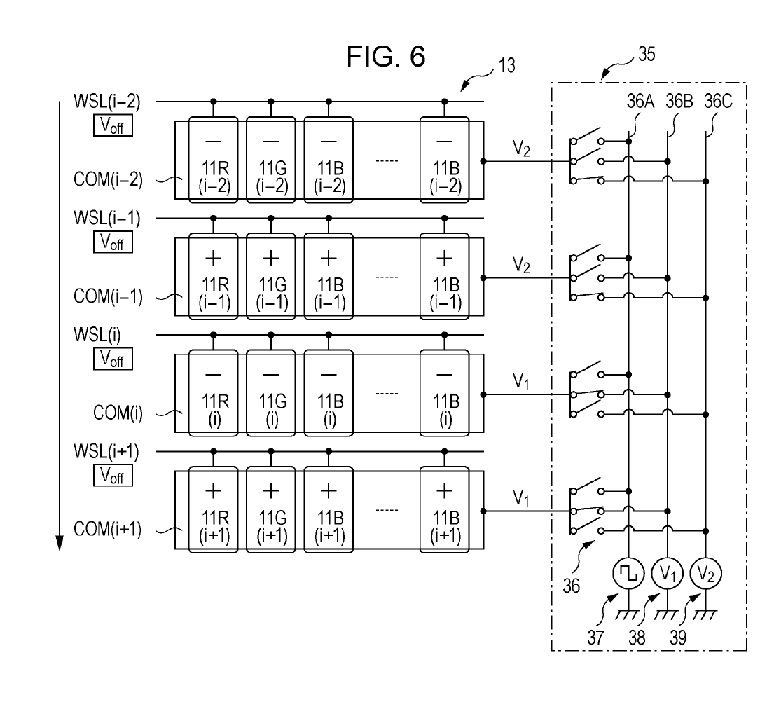

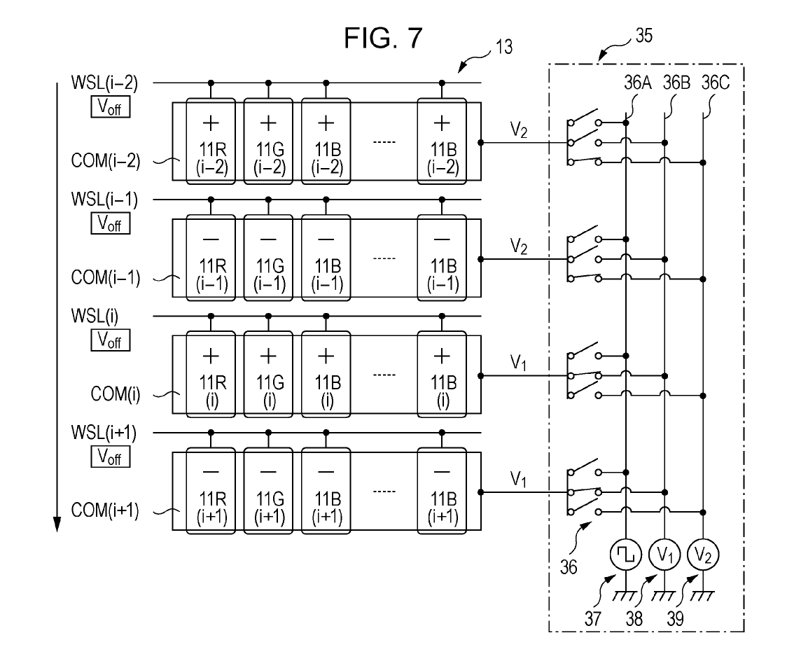

FIG. 4 schematically illustrates the polarity of each of the sub-pixels 11 at the timing when Vₒₙ is applied to the scanning line WSL(i) during the n−1 frame period in FIG. 3. FIG. 5 schematically illustrates the polarity of each of the sub-pixels 11 at the timing when Vₒₙ is applied to the scanning line WSL(i+1) during the n−1 frame period in FIG. 3. FIG. 6 schematically illustrates the polarity of each of the sub-pixels 11 immediately after the voltage of the common connection line COM corresponding to the sub-pixel 11R(i−1) is changed from V₁ to V₂ (which will be described further below) during the n−1 frame period in FIG. 3. FIG. 7 schematically illustrates the polarity of each of the sub-pixels 11 immediately after the voltage of the common connection line COM corresponding to the sub-pixel 11R(i−1) is changed from V₁ to V₂ (which will be described further below) during the n frame period in FIG. 3. Here, in FIGS. 4 to 7, the polarities of the sub-pixels 11 when the signal line drive circuit 33 performs 1H inversion driving and also frame inversion driving are illustrated. Here, in FIGS. 4 and 5, sub-pixels 11 each enclosed in a bold frame mean that these sub-pixels 11 have been selected with the scanning line WSL(i) or the scanning line WSL(i+1). Also, in FIGS. 4 to 7, sub-pixels 11 each enclosed in a thin frame mean that selection of these sub-pixels 11 with the scanning line WSL has been completed and the state is during a holding period Tₕ. Furthermore, in FIGS. 4 and 5, sub-pixels 11 each enclosed in a dotted frame mean that these sub-pixels 11 have not yet been selected with any scanning line.

Here, “the polarity of each of the sub-pixels 11” means a positive or negative polarity of the voltage of the sub-pixel 11 (dotted lines in FIG. 3) in relation to the voltages (V_{L} and V_{H}) (V_{L}<V_{H}) of the common connection line COM during a write period T. For example, as depicted in FIG. 3, when Vₒₙ is applied to the scanning line WSL(i), for example, the voltage of a sub-pixel 11R(i+1) is a negative voltage in relation to the voltage V_{H}. Therefore, in this case, the sub-pixel 11R(i) is referred to as having a negative polarity. On the other hand, for example, when Vₒₙ is applied to the scanning line WSL(i+1), for example, the voltage of a sub-pixel 11R(i+1) is a positive voltage in relation to the voltage V_{L}. Therefore, in this case, the sub-pixel 11R(i+1) is referred to as having a positive polarity.

The common connection line drive circuit 35 performs common inversion driving of inverting the polarity of a voltage to be supplied to the common electrode (the common connection line COM) for each predetermined line while the signal line drive circuit 33 is performing 1H inversion driving. Specifically, the common connection line drive circuit 35 applies, to the common connection line COM corresponding to the selected sub-pixel 11, a voltage having a polarity with respect to the reference voltage V_{ref} opposite to the polarity of the signal line DTL with respect to the reference voltage V_{ref}. For example, as depicted in FIGS. 3 to 6, when the polarity of the signal line DTL with respect to the reference voltage V_{ref} is positive, the common connection line drive circuit 35 applies, to the common connection line COM, a voltage V_{L} with the polarity with respect to the reference voltage V_{ref} being negative. Also, for example, as depicted in FIGS. 3 to 6, when the polarity of the signal line DTL with respect to the reference voltage V_{ref} is negative, the common connection line drive circuit 35 applies, to the common connection line COM, a voltage V_{H} with the polarity with respect to the reference voltage V_{ref} being positive.

Also, during a holding period Tₕ, the common connection line drive circuit 35 applies, to the common electrode (the common connection line COM), voltages of a plurality of types different in voltage from each other. For example, as depicted in FIGS. 3 to 6, the common connection line drive circuit 35 sequentially applies voltages V₁ and V₂ of two types (V₁>V₂) during the holding period Tₕ.

The common connection line drive circuit 35 electrically connects the common connection lines COM applied with an equal voltage together during the holding period Tₕ. For example, as depicted in FIGS. 3 and 6, during the holding period Tₕ, the common connection line drive circuit 35 electrically connects the common connection lines COM(i) and COM(i+1) applied with the voltage V₁ together, among the plurality of common connection lines COM disposed correspondingly to the non-selected sub-pixels 11. Also, for example, as depicted in FIGS. 3 and 6, during the holding period Tₕ, the common connection line drive circuit 35 electrically connects the common connection lines COM(i−2) and COM(i−1) applied with the voltage V₂ together, among the plurality of common connection lines COM disposed correspondingly to the non-selected sub-pixels 11. Here, preferably, the voltage V₁ and the voltage V₂ do not largely differ from each other.

Here, the common connection line drive circuit 35 electrically separates the common connection line COM disposed correspondingly to the selected sub-pixel 11 and the plurality of common connection lines COM disposed correspondingly to the non-selected sub-pixels 11, during the holding period Tₕ. For example, as depicted in FIGS. 3 and 5, during the holding period Tₕ, the common connection line drive circuit 35 electrically separates the common connection line COM(i+1) applied with the voltage V_{L} and the common connection lines COM(i−2), COM(i−1), and COM(i) applied with the voltage V₁. Also, during the holding period Tₕ, the common connection line drive circuit 35 electrically separates the common connection lines COM applied with different voltages among the plurality of common connection lines COM disposed correspondingly to the non-selected sub-pixels 11. For example, as depicted in FIGS. 3 and 6, during the holding period Tₕ, the common connection line drive circuit 35 electrically separates the common connection lines COM(i) and COM(i+1) applied with the voltage V₁ and the common connection lines COM(i−2) and COM(i−1) applied with the voltage V₂.

Furthermore, in the present embodiment, as depicted in FIGS. 3, 6, and 7, the common connection line drive circuit 35 performs common inversion driving of inverting the polarity of the voltage to be supplied to the common electrode (the common connection line COM) for each frame period while the signal line drive circuit 33 is performing frame inversion driving. For example, as depicted in FIGS. 6 and 7, the common connection line drive circuit 35 inverts the polarity of the voltage to be applied to the sub-pixel 11 for each frame period so that the polarity of the sub-pixel 11 after the n−1 frame period has elapsed is opposite to the polarity of the sub-pixel 11 after the n frame period has elapsed.

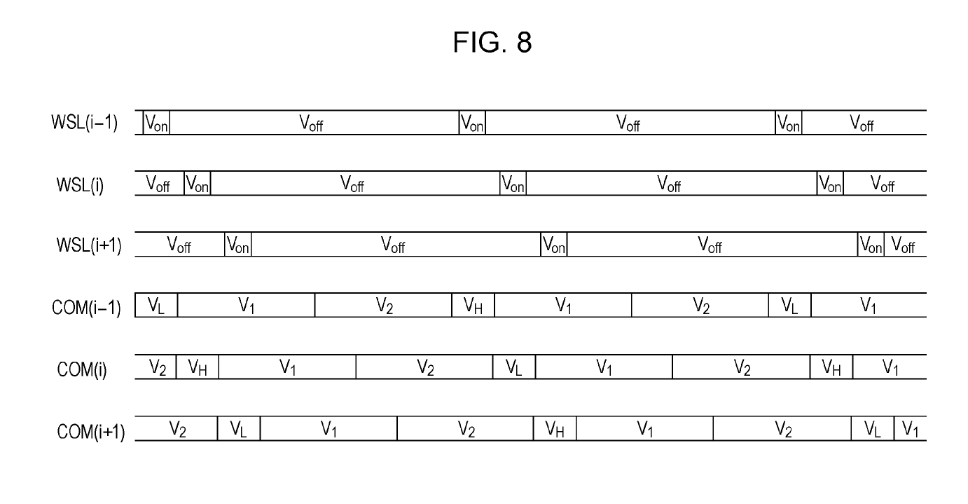

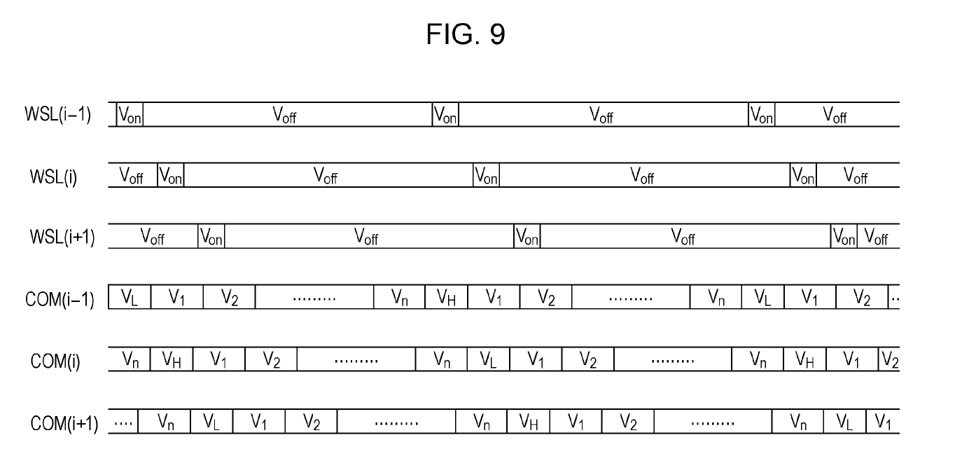

Here, the types of voltage during the holding period Tₕ are preferably the same for each frame period. For example, as depicted in FIG. 3, the type of voltage during the holding period Tₕ is preferably the same between a frame period (V_{H} frame period) in which V_{H} is applied during the write period T_{W} and a frame period (V_{L} frame period) in which V_{L} is applied during the write period T. The number of voltages during the holding period Tₕ may be two as depicted in FIG. 8, or may be three or more as depicted in FIG. 9. Here, FIG. 8 illustrates what is depicted in the waveform diagram in FIG. 3 as a state diagram. As with FIG. 8, FIG. 9 illustrates what is depicted in the waveform diagram as a state diagram.

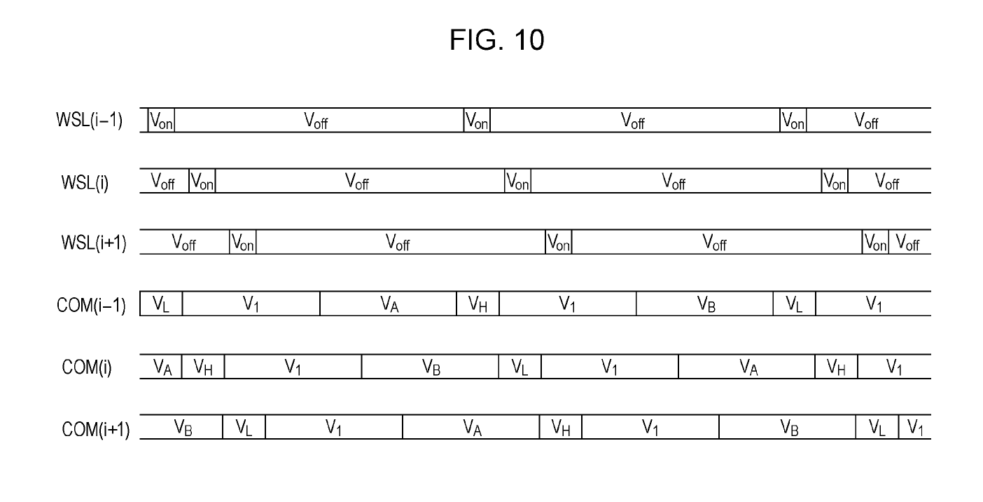

The type of voltage during the holding period Tₕ may not be the same during all frame periods. For example, the types of voltage may differ between the V_{H} frame period and the V_{L} frame period. Specifically, as depicted in FIG. 10, voltages of two types are sequentially applied during the holding period Tₕ, the second voltage V_{B} during the holding period Tₕ of the V_{H} frame period and the second voltage V_{A} during the holding period Tₕ of the V_{L} frame period may differ from each other. Here, the first voltage V₁ during the holding period Tₕ of the V_{H} frame period and the first voltage V₁ during the holding period Tₕ of the V_{L} frame period may be equal to each other or may differ from each other.

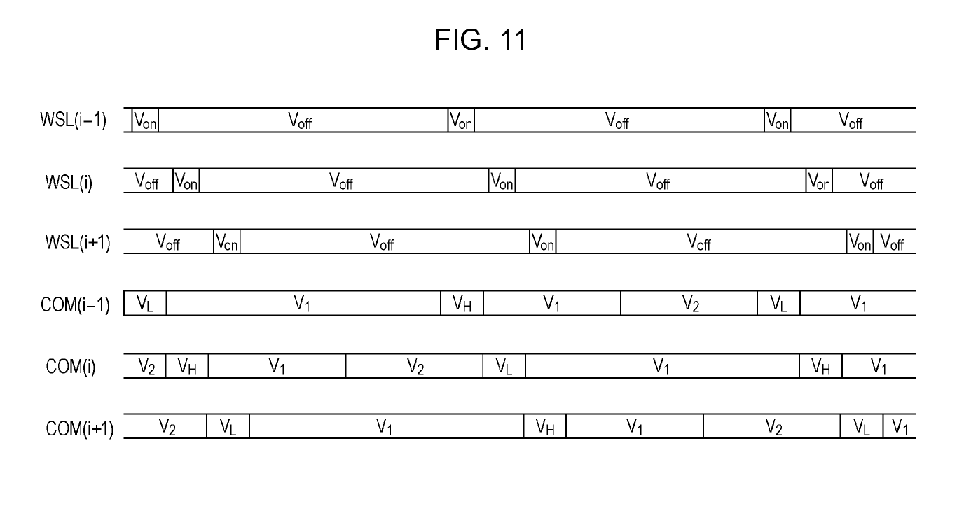

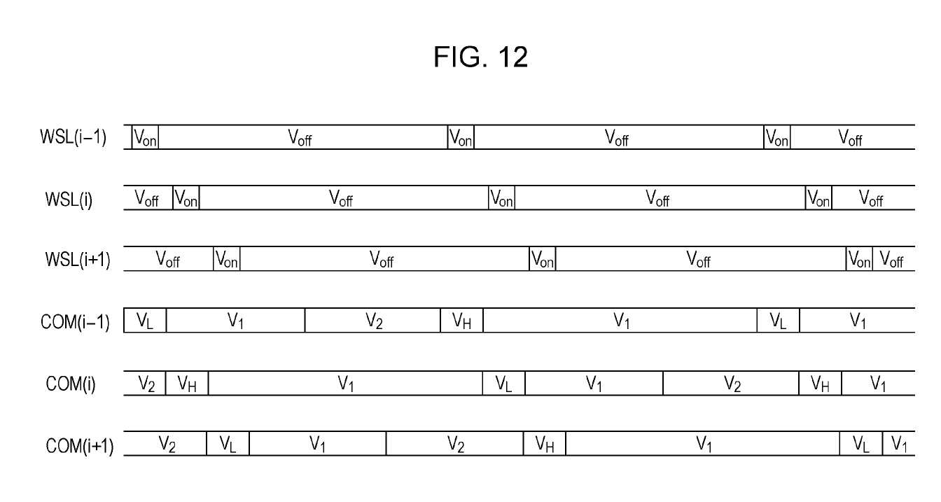

Also, the number of voltages during the holding period Tₕ may not be the same during all frame periods. For example, when the transistors 14 and 15 are p-type transistors, as depicted in FIG. 11, two types (V₁ and V₂) of voltage may be sequentially applied during the holding period Tₕ of the V_{H} frame period, and one type (V₁) of voltage may be applied during the holding period Tₕ of the V_{L} frame period. Here, the voltage to be applied during the holding period Tₕ of the V_{L} frame period may be equal to the first voltage during the holding period Tₕ of the V_{H} frame period. Furthermore, for example, when the transistors 14 and 15 are n-type transistors, as depicted in FIG. 12, a voltage of one type (V₁) may applied during the holding period Tₕ of the V_{H} frame period, and voltages of two types (V₁ and V₂) may be sequentially applied during the holding period Tₕ of the V_{L} frame period. Here, the voltage (V₁) to be applied during the holding period Tₕ of the Vₕ frame period may be equal to the first voltage (V₁) during the holding period T_{L} of the V_{H} frame period.

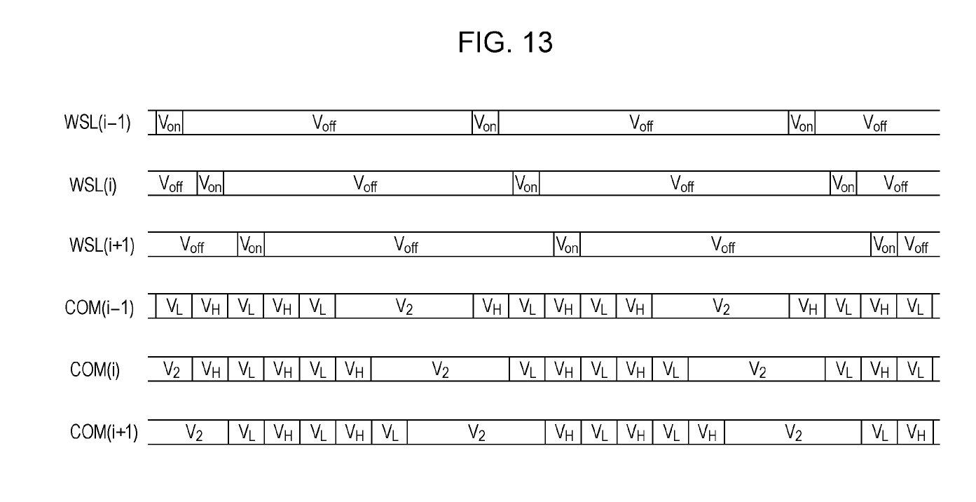

Still further, when a plurality of voltages are to be applied during the holding period Tₕ, at the beginning of the holding period Tₕ, voltages equal to the voltages (V_{H} and V_{L}) to be applied during the write period T_{w} may be applied in an AC manner (alternately). For example, as depicted in FIG. 13, voltages may be sequentially applied as V_{H}, V_{L}, V_{H}, V_{L}, . . . during the V_{H} frame period at the beginning of the holding period Tₕ, and voltages may be sequentially applied as V_{L}, V_{H}, V_{L}, V_{H}, . . . during the V_{L} frame period at the beginning of the holding period Tₕ.

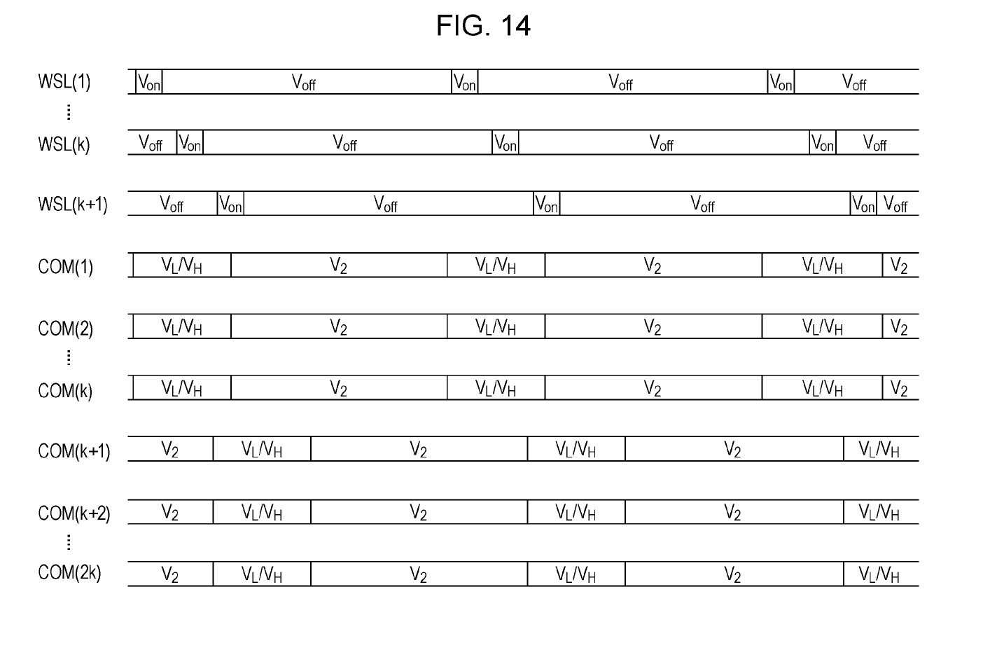

Still further, when a plurality of voltages are to be applied during the holding period Tₕ, the timing of applying the voltages during the holding period Tₕ may be shifted by 1H for each line in one field period, for example, as depicted in FIG. 3. Still further, when a plurality of voltages are to be applied during the holding period Tₕ, the timing of applying the voltages during the holding period Tₕ may be synchronized for every k line(s) (k is a positive integer) in one field period, for example, as depicted in FIG. 14. Here, the scanning timing is preferably shifted by 1H×k for each k line. Still further, during the holding period Tₕ in a predetermined frame period, the common connection line drive circuit 35 preferably sequentially applies the same type of voltage (V₂) to each desired unit (every k lines) of common connection lines COM with a shift by 1H×k. Still further, when the timing of applying the voltage during the holding period Tₕ is synchronized for every k line(s), the first voltage during the holding period Tₕ is preferably taken as V_{H} in the V_{H} frame period, and the first voltage during the holding period Tₕ is taken as V_{L} in the V_{L} frame period.

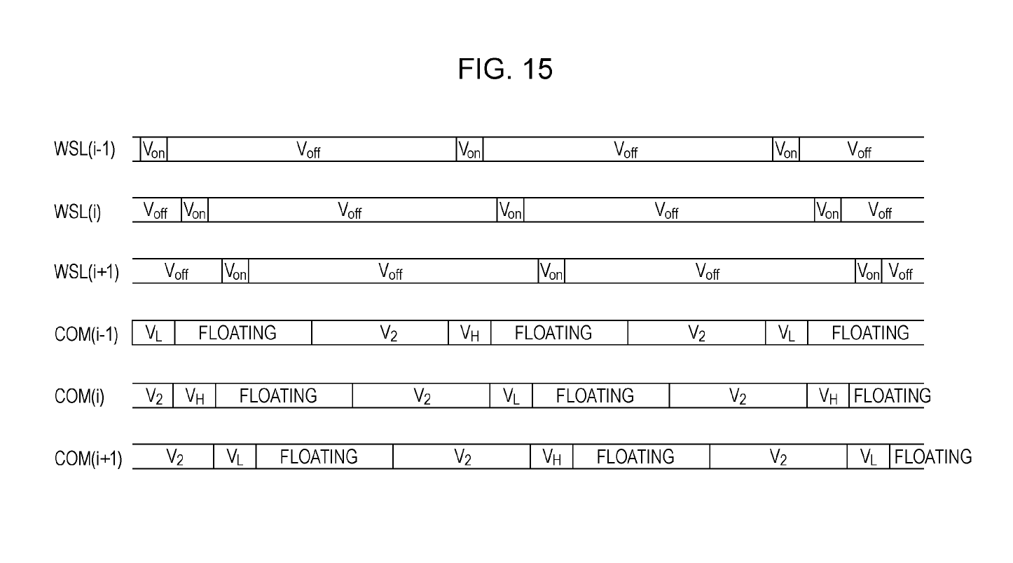

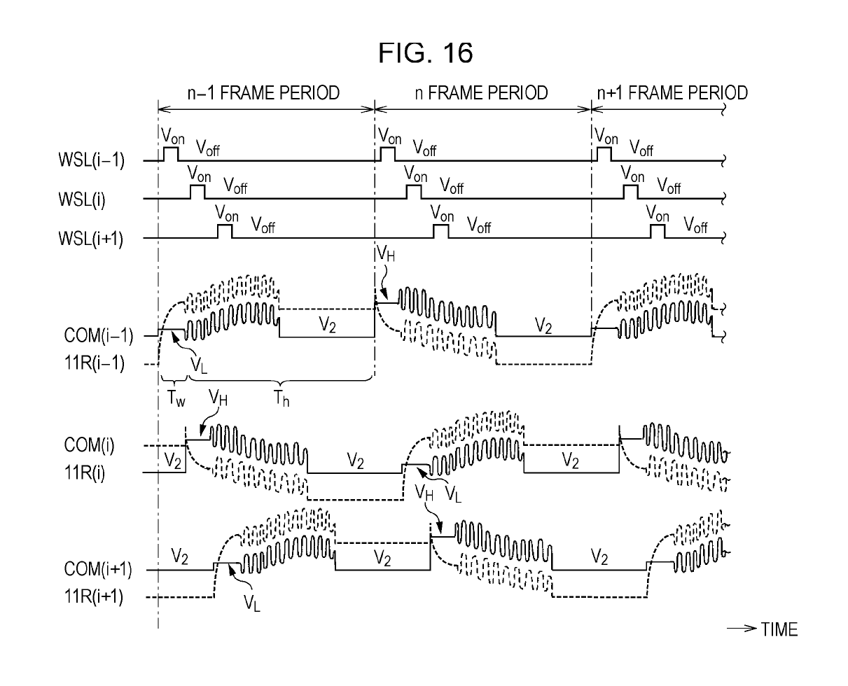

Still further, particularly as for a picture of nature, when a plurality of voltages are to be applied during the holding period Tₕ, one of these voltages may be a floating voltage. This is because, in a picture of nature, even when one voltage is a floating voltage, deterioration in image quality tends not to be recognized. For example, as depicted in FIG. 15, the first voltage during the holding period Tₕ may be a floating voltage. In this case, however, the common connection lines COM is susceptible to coupling from other wirings (for example, the signal lines DTL). Therefore, for example, as depicted in FIG. 16, the voltage of each common connection lines COM is wavy owing to coupling. Here, as will be described further below, the common connection lines COM in a floating state are connected together by the common connection line drive circuit 35. With this, by setting a certain common connection line COM in a floating state, the electric charge held immediately before the common connection line COM becomes in a floating state is distributed to other common connection lines COM already being in a floating state. As a result, the voltages of the common connection lines COM in a floating state wave to converge into a predetermined voltage (for example, a voltage equivalent to the voltage V₁ described above).

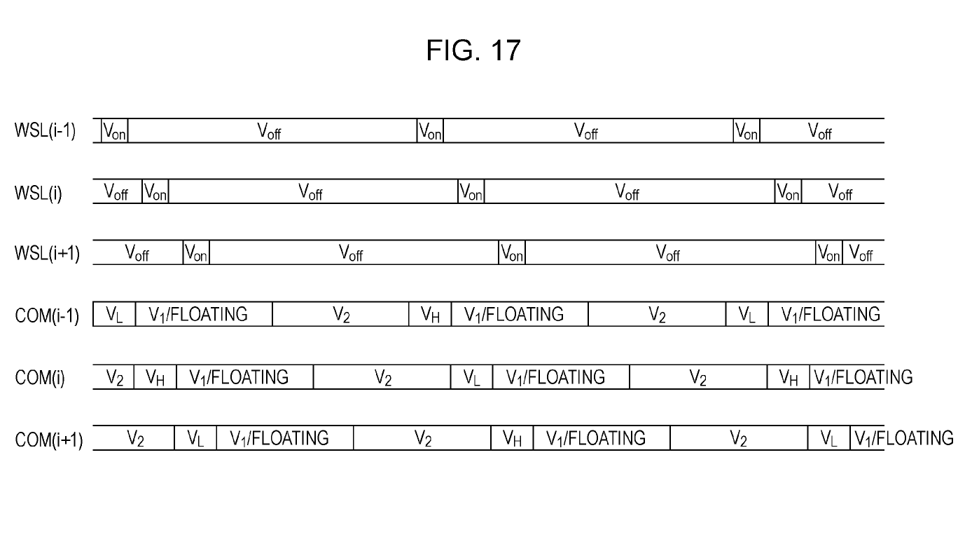

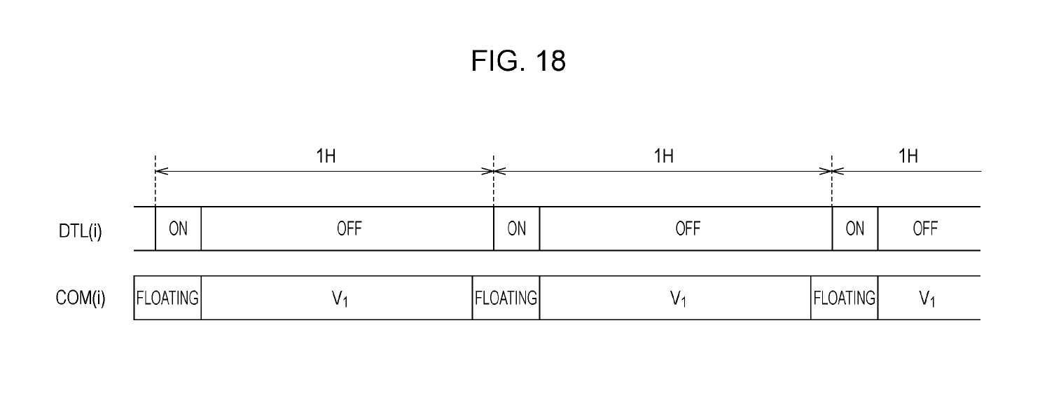

Still further, for example, in the first half of the holding period Tₕ, the predetermined voltage V₁ and a floating voltage may alternately be applied to the common connection line COM. For example, as depicted in FIGS. 17 and 18, in a 1H period, the voltage during an ON period (or a period including an ON period) in which a signal voltage corresponding to the video signal 30A is applied from the video signal processing circuit 31 to the signal line DTL(i) may be a floating voltage, and the voltage during the other periods may be V₁. Here, the ON period may include a period in which a pre-charge voltage is applied to the signal line DTL(i).

Next, the internal structure of the common connection line drive circuit 35 is described. Here, an example of the internal structure is described below in which the number of types of voltage during the holding period Tₕ is two.

The common connection line drive circuit 35 has, for example, as depicted in FIG. 4, a switching element 36 electrically connected to the common connection line COM. One switching element 36 is provided for each common connection line COM and, for example, has three output terminals. The first output terminal of the switching element 36 is connected to a wiring 36A, and is connected via the wiring 36A to an output terminal of a pulse generating device 37. The second output terminal of the switching element 36 is connected to a wiring 36B. The wiring 36B is connected to, for example, as depicted in FIG. 4, an output terminal of a constant voltage circuit 38. The constant voltage circuit 38 is configured to output a predetermined voltage V₁ to the wiring 36B. The third output terminal of the switching element 36 is connected to a wiring 36C. The wiring 36C is connected to, for example, as depicted in FIG. 4, an output terminal of a constant voltage circuit 39. The constant voltage circuit 39 is configured to output a predetermined voltage V₂ (<V₁) to the wiring 36C.

The common connection line drive circuit 35 connects, to the output terminal of the pulse generating device 37, a common connection line COM disposed correspondingly to a horizontal line of (selected) sub-pixels 11 that have been turned on with the application of Vₒₙ to the scanning line WSL. For example, as depicted in FIG. 4, the common connection line drive circuit 35 connects, via the switching element 36 and the wiring 36A to the output of the pulse generating device 37, the common connection line COM(i) disposed correspondingly to one row formed of the selected sub-pixels 11R(i), 11G(i), and 11B(i), and then sets the voltage at V_{H}. Also for example, as depicted in FIG. 5, the common connection line drive circuit 35 connects, via the switching element 36 and the wiring 36A to the output of the pulse generating device 37, the common connection line COM(i+1) disposed correspondingly to one row formed of the selected sub-pixels 11R(i+1), 11G(i+1), and 11B(i+1), and then sets the voltage at V_{L}.

Also, the common connection line drive circuit 35 connects to the wiring 36B a common connection line COM disposed correspondingly to a horizontal line for which a predetermined non-selection time has not elapsed among the plurality of horizontal lines formed of (non-selected) sub-pixels 11 that have been turned off with the application of voltage V_{off} to the scanning line WSL, until the predetermined non-selection time elapses. For example, as depicted in FIGS. 3 and 5, the common connection line drive circuit 35 connects, via the switching element 36 to the wiring 36B, the common connection lines COM(i−2), COM(i−1), and COM(i) disposed correspondingly to three rows formed of the non-selected sub-pixels 11R(i−2), 11R(i−1), and 11R(i), and then sets the voltage at V₁.

Furthermore, the common connection line drive circuit 35 connects to the wiring 36C a common connection line COM disposed correspondingly to a horizontal line for which a predetermined non-selection time has elapsed among the plurality of horizontal lines formed of (non-selected) sub-pixels 11 that have been turned off with the application of voltage V_{off} to the scanning line WSL. For example, as depicted in FIGS. 3 and 6, the common connection line drive circuit 35 connects, via the switching element 36 to the wiring 36C, the common connection lines COM(i−2) and COM(i−1) disposed correspondingly to two rows formed of the non-selected sub-pixels 11R(i−2) and 11R(i−1), and then sets the voltage at V₂.

Here, when the number of types of voltage during the holding period Tₕ is three or more, the common connection line drive circuit 35 can be configured as described below, for example, although not shown. That is, the common connection line drive circuit 35 can include, for example, the switching element 36, the pulse generating device 37, constant voltage circuits of three types or more, the wiring 36A connected to the pulse generating device 37, and wirings connected to each of the constant voltage circuits.

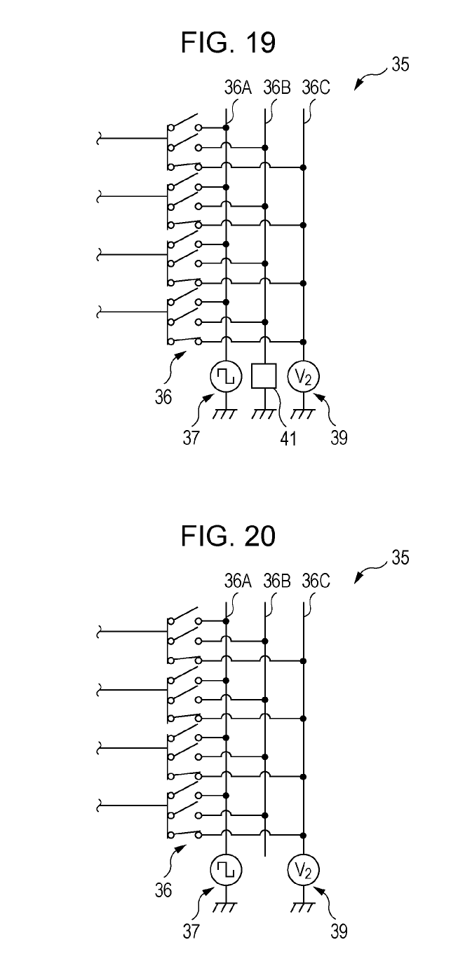

Also, the common connection line drive circuit 35 may include a logic circuit in place of the constant voltage circuits 38 and 39. For example, as depicted in FIG. 19, the common connection line drive circuit 35 may include a logic circuit 41 in place of the constant voltage circuit 38. Furthermore, although not shown, one more common connection line drive circuit 35 may further be provided to another end of the common connection line COM.

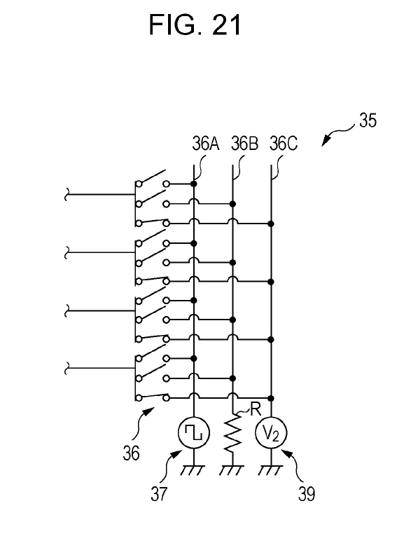

When a plurality of voltages are to be applied during the holding period Tₕ and one of these voltages is a floating voltage, the common connection line drive circuit 35 can be configured as described below, for example. That is, the common connection line drive circuit 35 can include, for example, as depicted in FIG. 20, the switching element 36, the pulse generating device 37, the constant voltage circuit 39, the wiring 36A connected to the pulse generating device 37, the wiring 36B being in a floating state, and the wiring 36C connected to the constant voltage circuit 39. Furthermore, for example, as depicted in FIG. 21, the common connection line drive circuit 35 may include a high resistor R between the wiring 36B being in a floating state and the ground. In this case, the wiring 36B can be considered as being in a substantially floating state.

Next, the operation of the liquid crystal display apparatus 1 according to the present embodiment is described. Here, the operation with two types of voltage during the holding period Tₕ is described below.

### Write Period T_{w}

In a write period T_{w}, which is the first half of each frame period, the voltage Vₒₙ is applied by the scanning line drive circuit 34 to a desired unit of a plurality of scanning lines WSL, thereby turning the transistors 14 and 15 on. Furthermore, the signal voltage V_{sig} is applied by the signal line drive circuit 33 to each signal line DTL, and the voltage V_{L} or the voltage V_{H} is applied by the common connection line drive circuit 35 to the common connection lines COM corresponding to the selected sub-pixels 11.

Here, the signal voltage V_{sig} whose polarity is inverted for each 1H period and each frame period in relation to the reference voltage V_{ref} is applied by the signal line drive circuit 33 to each signal line DTL (1H inversion driving and frame inversion driving). Furthermore, in the write period T_{w} of each frame period, a voltage having a polarity with respect to the reference voltage V_{ref} opposite to the polarity of the signal line DTL with respect to the reference voltage V_{ref} is applied by the common connection line drive circuit 35 to the common connection line COM corresponding to the selected sub-pixel 11 (common inversion driving). With this, in the write period T_{w}, the voltage V_{w} corresponding to the signal voltage V_{sig} is written in the selected sub-pixels 11 (refer to FIG. 3). Here, in the present embodiment, in writing the voltage V_{w}, 1H inversion driving, frame inversion driving, and common inversion driving are performed. With this, the amplitude of the signal voltage to be applied to the sub-pixels 11 can be decreased, thereby suppressing power consumption.

### Holding Period Tₕ

In the holding period Tₕ, which is the latter half of each frame period, the voltage V_{off} is applied by the scanning line drive circuit 34 to the scanning lines WSL corresponding to the non-selected sub-pixels 11, thereby turning the transistors 14 and 15 off. With this, the voltage V_{w} written during the write period T_{w} is held in the non-selected sub-pixels 11. As a result, each sub-pixel 11 lights up with a luminance corresponding to the voltage V.

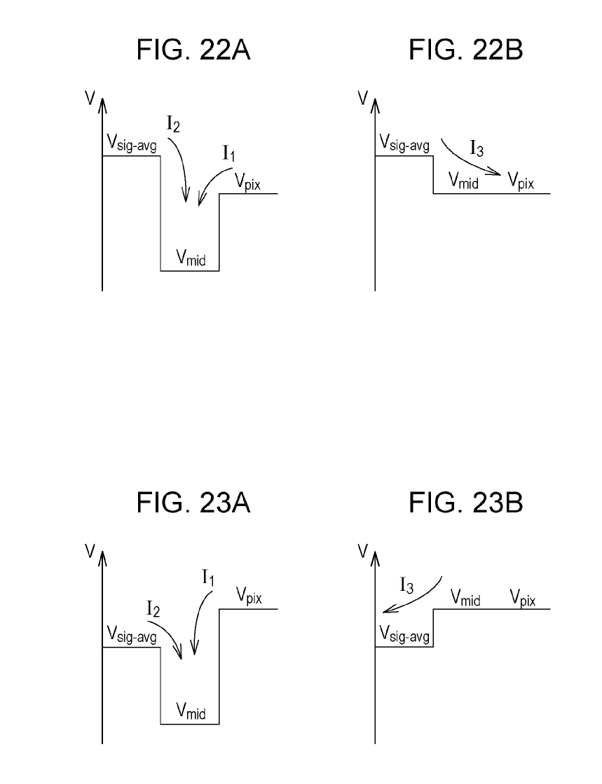

Meanwhile, in principle, it is not easy to keep the voltage V_{w} of the holding period Tₕ constant all through the holding period Tₕ. For example, in the V_{H} frame period, as depicted in FIGS. 2 and 22A, when the transistors 14 and 15 are turned off, a voltage V_{mid} of a middle node, which is a connecting point between the transistor 14 and the transistor 15, is subjected to coupling to be drawn in a negative direction. With this, the voltage V_{mid} becomes close to an OFF voltage of the transistors 14 and 15. Thus, a leak current I₁ flows from the liquid crystal element 16 toward the transistors 14 and 15, and a leak current I₂ flows from the signal line DTL toward the transistors 14 and 15. Also, immediately after writing during the V_{H} frame period, as depicted in FIG. 22B, a voltage Vₚᵢₓ of the liquid crystal element 16 is lower than a voltage V_{sig-avg}, which is an average value of voltages of the signal lines DTL with the polarity inverted for each 1H. Thus, a leak current I₃ flows from the signal line DTL toward the transistors 14 and 14 and 15.

Also, for example, in the V_{L} frame period, as depicted in FIGS. 2 and 23A, when the transistors 14 and 15 are turned off, the voltage V_{mid} of the middle node, which is a connecting point between the transistor 14 and the transistor 15, is subjected to coupling to be drawn in a negative direction. With this, the voltage V_{mid} becomes close to the OFF voltage of the transistors 14 and 15. Thus, the leak current I₁ flows from the liquid crystal element 16 toward the transistors 14 and 15, and the leak current I₂ flows from the signal line DTL toward the transistors 14 and 15. Furthermore, immediately after writing during the V_{L} frame period, as depicted in FIG. 23B, the voltage Vₚᵢₓ of the liquid crystal element 16 is higher than the voltage V_{sig-avg}, which is an average value of voltages of the signal lines DTL with the polarity inverted for each 1H. Thus, the leak current I₃ flows from the transistors 14 and 15 toward the signal line DTL.

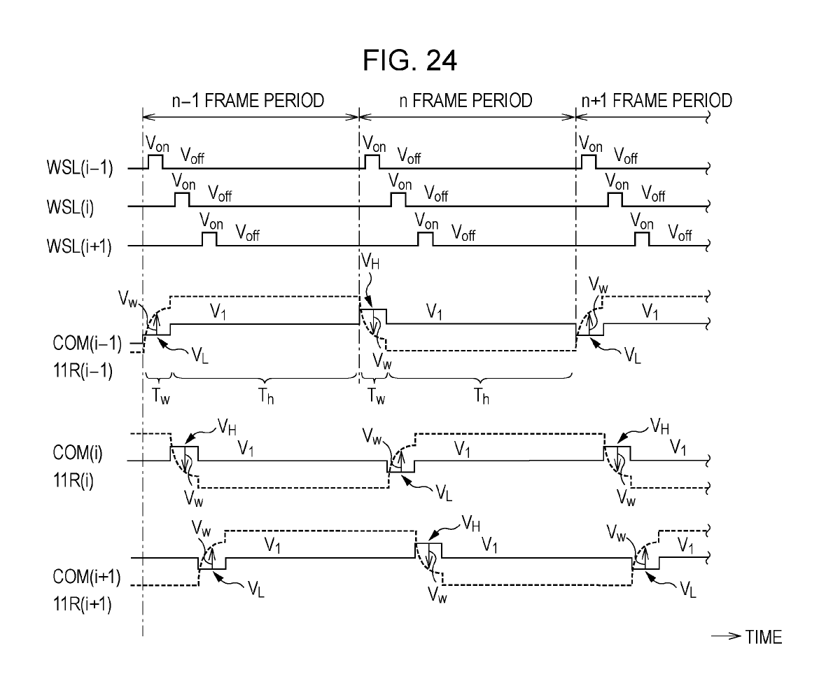

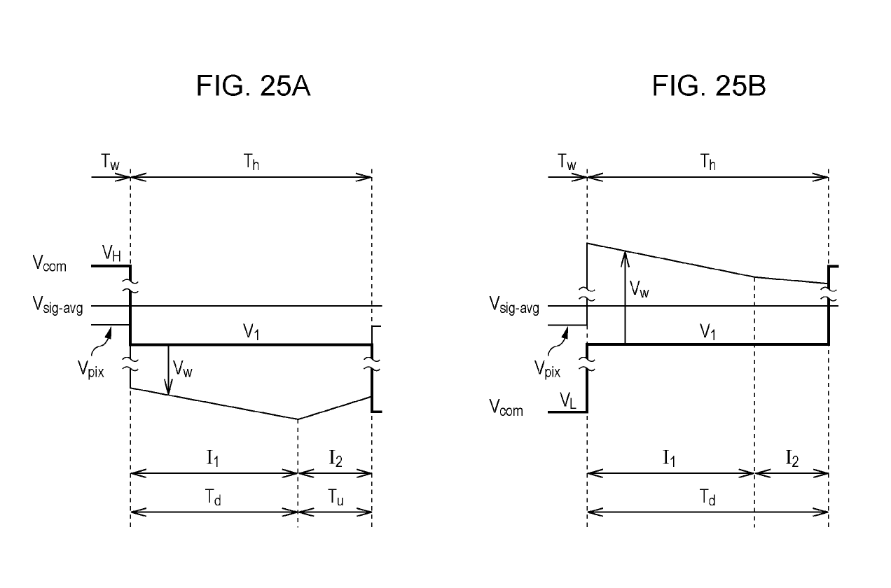

Therefore, for example, as depicted in FIG. 24, when a constant voltage is continuously applied by the common connection line drive circuit 35 to the common connection lines COM corresponding to the non-selected sub-pixels 11 during the holding period Tₕ, the voltage Vₚᵢₓ becomes as depicted in FIGS. 25A and 25B. That is, during the V_{H} frame period, as depicted in FIG. 25A, the voltage Vₚᵢₓ is changed in a negative direction during the first half of the holding period Tₕ, and then is changed in a positive direction. In this manner, during the V_{H} frame period, the holding period Tₕ has a period T_{d}, in which the voltage Vₚᵢₓ is changed in a negative direction, in the first half and a period Tᵤ, in which the voltage Vₚᵢₓ is changed in a positive direction, in the latter half. On the other hand, during the V_{L} frame period, as depicted in FIG. 25B, the voltage Vₚᵢₓ is changed in a negative direction both in the first half and the latter half of the holding period Tₕ. In this manner, during the V_{L} frame period, the holding period Tₕ has only the period T_{d}, in which the voltage Vₚᵢₓ is changed in a negative direction. This means that, no matter how the value of the voltage V₁ of the common connection line COM is adjusted, it is difficult to equalize the average values of the written voltages V_{w} (average values of voltages applied to the liquid crystal element 16) in the first half and the latter half of the holding period Tₕ of the V_{L} frame period.

Here, FIGS. 25A and 25B illustrate waveforms when the transistors 14 and 15 are of n type. When the transistors 14 and 15 are of p type, the holding period Tₕ has only the period Tᵤ, in which the voltage Vₚᵢₓ is changed in a positive direction, in the V_{H} frame period, and has the period T_{d}, in which the voltage Vₚᵢₓ is changed in a negative direction, and the period Tᵤ, in which the voltage Vₚᵢₓ is changed in a positive direction, in the V_{L} frame period.

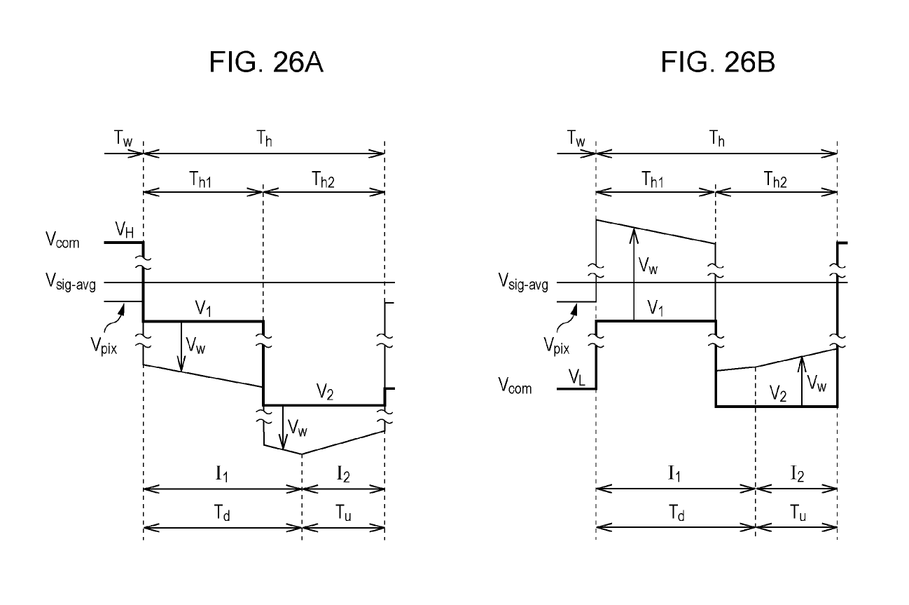

On the other hand, in the present embodiment, for example, as depicted in FIG. 3, during the holding period Tₕ, voltages of a plurality of (two) types are applied by the common connection line drive circuit 35 to the common connection lines COM corresponding to the non-selected sub-pixels 11. With this, the voltage Vₚᵢₓ becomes as depicted in FIGS. 26A and 26B. That is, during the V_{H} frame period, as depicted in FIG. 26A, the voltage Vₚᵢₓ is changed in a negative direction during the first half of the holding period Tₕ, and then is changed in a positive direction. In this manner, during the V_{H} frame period, the holding period Tₕ has the period T_{d}, in which the voltage Vₚᵢₓ is changed in a negative direction, in the first half and the period Tᵤ, in which the voltage Vₚᵢₓ is changed in a positive direction, in the latter half. Also during the V_{L} frame period, as depicted in FIG. 26B, the voltage Vₚᵢₓ is changed in a negative direction during the first half of the holding period Tₕ, and then is changed in a positive direction. In this manner, also during the V_{L} frame period, the holding period Tₕ has the period T_{d}, in which the voltage Vₚᵢₓ is changed in a negative direction, in the first half and the period Tᵤ, in which the voltage Vₚᵢₓ is changed in a positive direction, in the latter half. Therefore, in the present embodiment, by adjusting the voltages V₁ and V₂ of the common connection lines COM and adjusting the lengths of application periods (Tₕ₁ and Tₕ₂), the average values of the written voltages V_{w} (the average values of the voltages applied to the liquid crystal element 16) can be equalized in the first half and the latter half of the holding period Tₕ both in the V_{H} frame period and the V_{L} frame period.

In other words, in the present embodiment, the sub-pixels 11 are driven so that the holding period Tₕ in each frame period has a period (T_{d}) in which the voltage of one liquid crystal element 16 falls and a period (Tᵤ) in which the voltage rises. Furthermore, voltages of a plurality of (two) types are applied to a plurality of common connection lines COM so that the average values of voltages applied to the liquid crystal element 16 are equalized in a period (Tₕ₁) in which a voltage of one type (V₁) is applied and a period (Tₕ₂) in which a voltage of another type (V₂) is applied.

With this, luminance values of the sub-pixels 11 can be equalized in the period Tₕ₁ and the period Tₕ₂. As a result, flicker can be reduced. Meanwhile, in the present embodiment, the length of each frame period does not have to be shorter than the length in the past (that is, the frame frequency does not have to be increased). Thus, flicker can be reduced even without driving at high speed. Also, by driving at low speed (driving at low frequency) as long as the flicker level satisfies specifications, power consumption can be further lowered. Furthermore, with the reduction of flicker, the luminance of the backlight 20 can be increased as ever before. As a result, image quality, such as contrast and luminance, can be increased, while suppressing flicker. Still further, in the present embodiment, since the structure and shape of the sub-pixels 11 are not subjected to any constraint, it is possible to prevent a decrease in the aperture ratio and an increase in the number of masks for use in manufacturing process.

Here, in the present embodiment, irrespectively of whether the type of voltage of the common connection lines COM during the holding period Tₕ is the same for each frame period or not the same during all frame periods, the average voltages of the written voltages V_{w} can be equalized in the Tₕ holding period of the V_{H} frame period and the V_{L} frame period. Also, even when the number of voltages of the common connection line COM during the holding period Tₕ is not the same during all frame periods, the average voltages of the written voltages V_{w} can be equalized in Tₕ holding period of the V_{H} frame period and the V_{L} frame period.

Furthermore, in the present embodiment, the common connection lines COM disposed correspondingly to the selected sub-pixels 11 and the plurality of common connection lines COM disposed correspondingly to the non-selected sub-pixels 11 are electrically separated from each other during the holding period Tₕ. With this, compared with the case in which a common electrode is provided to all sub-pixels 11, the capacitance at the time of driving can be decreased. Still further, in the present embodiment, among the plurality of common connection lines COM disposed correspondingly to the non-selected sub-pixels 11, the common connection lines COM applied with different voltages are electrically separated from each other during the holding period Tₕ. With this, in the non-selected sub-pixels 11, a difference in potential does not occurs among the common connection lines COM applied with the same voltage. With this, the common connection lines COM can be charged and discharged at high speed, while power consumption and light dropout are both suppressed.

Here, preferably, various voltages to be applied during the holding period Tₕ do not largely differ from each other. In this case, since a large electric field does not occur in a lateral direction among the common connection lines COM applied with different voltages, light dropout in this portion can be reduced.

Also, in the present embodiment, as depicted in FIGS. 6 and 7, while the signal line drive circuit 33 is performing frame inversion driving, common inversion driving is performed in which the polarity of the voltage to be supplied to the common electrode (the common connection line COM) is inverted for each frame period. With this, the amplitude of the signal voltage applied to the sub-pixel 11 can be decreased, thereby further suppressing power consumption.

Furthermore, in the present embodiment, for example, as depicted in FIGS. 15 to 18, when the common connection lines COM are set in a floating state for a predetermined period, the wiring capacity of the signal lines DTL and the common connection lines COM is dramatically decreased. As a result, power consumption can be further suppressed.

Still further, in the present embodiment, for example, as depicted in FIG. 19, the logic circuit 41 may be provided in place of the constant voltage circuit 38, and a period in which the potentials of the common connection lines COM during the holding period are unstable owing to floating (a waving period in FIG. 16) and other periods (non-waving periods in FIG. 16) may be controlled by the logic circuit 41. With this, advantages of a decrease in power consumption by floating and a decrease in noise by charging from a constant current source can be both obtained.

Still further, although not shown, when one more common connection line drive circuit 35 is provided at another end of the common connection line COM, the driving capability of the common connection line COM can be enhanced. Another Embodiment

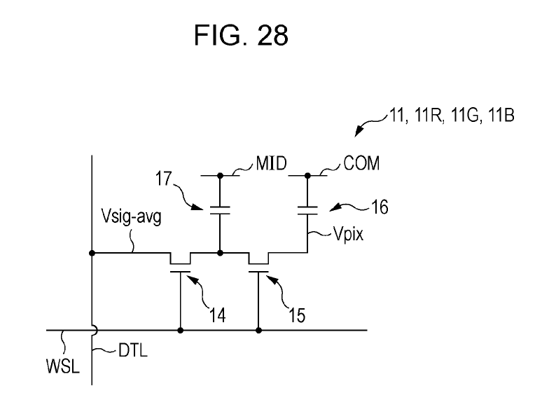

FIG. 27 illustrates a schematic structure of a liquid crystal display apparatus 2 according to another embodiment of the present invention. FIG. 28 illustrates an example of internal structure of a sub-pixel 11 of the liquid crystal display apparatus 2 in FIG. 27. The liquid crystal display apparatus 2 is different in structure from the liquid crystal display apparatus 1 according to the embodiment described earlier in that a middle node line MID is connected to a middle node and a middle node line drive circuit 51 is connected to the middle node line MID. Furthermore, the liquid crystal display apparatus 2 is different in structure from the liquid crystal display apparatus 1 according to the embodiment described earlier in that a common connection line drive circuit 52 is provided in place of the common connection line drive circuit 35. Therefore, details in common with those of the embodiment described earlier are not described, and differences from the embodiment described earlier are mainly described below.

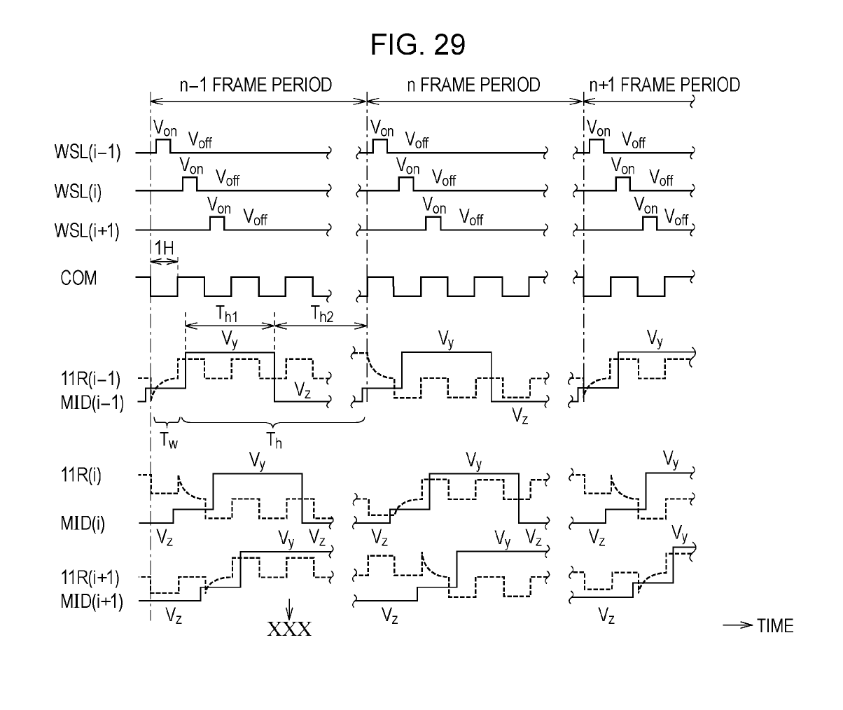

FIG. 29 is a timing diagram illustrating an example of operation of the liquid crystal display apparatus 2. In FIG. 29, waveforms in an n−1 frame period, an n frame period, and an n+1 frame period are depicted.

As depicted above, the liquid crystal display apparatus 2 includes a middle node line MID connected to the middle node. This middle node line MID has a wiring capacitance 17, as depicted in FIG. 28. Also, as described above, the liquid crystal display apparatus 2 includes the common connection line drive circuit 52 in place of the common connection line drive circuit 35. For example, as depicted in FIG. 28, the common connection line drive circuit 52 applies a rectangular wave of a 2H period to the common connection line COM. Here, as with the embodiment described earlier, the common connection line COM may be a band-shaped electrode provided for each horizontal line (one row), or may be a plate-shaped electrode provided correspondingly to all sub-pixels 11.

Also, as described above, the liquid crystal display apparatus 2 includes the middle node line drive circuit 51 connected to the middle node line MID. For example, as depicted in FIG. 29, the middle node line drive circuit 51 sets the middle node line MID to be in a floating state during the write period T. Here, the middle node line MID is subjected to coupling by receiving fluctuations in the voltage Vₚᵢₓ during writing in the same line (row). Thus, the voltage of the middle node line MID fluctuates in an AC manner, with a predetermined voltage value as an average (not shown). Also, for example, as depicted in FIG. 29, the middle node line drive circuit 51 sequentially applies voltages of two types V_{y} and V_{z} (V_{y}>V_{z}) during the holding period Tₕ.

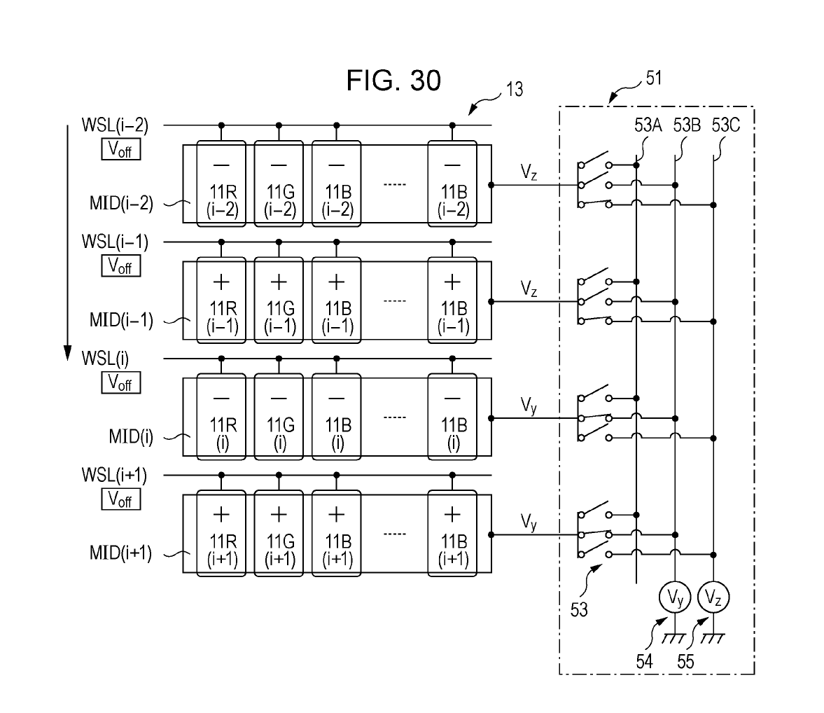

The middle node line drive circuit 51 electrically connects middle node lines MID applied with the same voltage together during the holding period Tₕ. For example, as depicted in FIGS. 29 and 30, among the plurality of middle node lines MID disposed correspondingly to the non-selected sub-pixels 11 the middle node line drive circuit 51 electrically connects middle node lines MID(i) and MID(i+1) applied with the voltage V_{y} together during the holding period Tₕ. Also, for example, as depicted in FIGS. 29 and 30, among the plurality of middle node lines MID disposed correspondingly to the non-selected sub-pixels 11, the middle node line drive circuit 51 electrically connects middle node lines MID(i−2) and MID(i−1) applied with the voltage V_{z} together during the holding period Tₕ.

For example, as depicted in FIG. 30, the middle node line drive circuit 51 has a switching element 53 electrically connected to the middle node line MID. One switching element 53 is provided for each middle node line MID, and has, for example, three output terminals. The first output terminal of the switching element 53 is connected to a wiring 53A being in a floating state. The second output terminal of the switching element 53 is connected to a wiring 53B. For example, as depicted in FIG. 30, the wiring 53B is connected to an output terminal of a constant voltage circuit 54. The constant voltage circuit 54 is configured to output a predetermined voltage V_{y} to the wiring 53B. The third output terminal of the switching element 53 is connected to a wiring 53C. For example, as depicted in FIG. 30, the wiring 53C is connected to an output terminal of a constant voltage circuit 55. The constant voltage circuit 55 is configured to output a predetermined voltage V_{z} (<V_{y}) to the wiring 53C.

The middle node line drive circuit 51 connects, to the wiring 53A being in a floating state, a middle node line MID disposed correspondingly to a horizontal line of (selected) sub-pixels 11 that have been turned on with the application of Vₒₙ to the scanning line WSL, and then sets the voltage at Vₓ.

Also, the middle node line drive circuit 51 connects to the wiring 53B a middle node line MID disposed correspondingly to a horizontal line for which a predetermined non-selection time has not elapsed among the plurality of horizontal lines formed of (non-selected) sub-pixels 11 that have been turned off with the application of voltage V_{off} to the scanning line WSL, until the predetermined non-selection time elapses, and then sets the voltage at V_{y}. Furthermore, the middle node line drive circuit 51 connects to the wiring 53C a middle node line MID disposed correspondingly to a horizontal line for which a predetermined non-selection time has elapsed among the plurality of horizontal lines formed of (non-selected) sub-pixels 11 that have been turned off with the application of voltage V_{off} to the scanning line WSL, and then sets the voltage at V_{z}.

Here, the middle node line drive circuit 51 may include a switching element having two output terminals in place of the switching element 53 and, furthermore, the wiring 53A may be omitted from the middle node line drive circuit 51. In this case, in place of connecting one output terminal of the switching element 53 to the wiring 53A, the middle node line drive circuit 51 releases (opens) two output terminals of the switching element.

Also, when the number of types of voltage during the holding period Tₕ is three or more, the middle node line drive circuit 51 can be configured as described below, for example, although not shown. That is, the middle node line drive circuit 51 can include, for example, the switching element 53, constant voltage circuits of three types or more, the wiring 53A being in a floating state, and wirings connected to each of the constant voltage circuits. Also, the middle node line drive circuit 51 may include a logic circuit in place of the constant voltage circuits 54 and 55.

Meanwhile, in the present embodiment, for example, as depicted in FIG. 29, during the holding period Tₕ, voltages of a plurality of (two) types are applied by the middle node line drive circuit 51 to the middle node lines MID corresponding to the non-selected sub-pixels 11. With this, the voltage Vₚᵢₓ has waveforms as depicted in FIGS. 26A and 26B. That is, during the V_{H} frame period, as depicted in FIG. 26A, the voltage Vₚᵢₓ is changed in a negative direction during the first half of the holding period Tₕ, and then is changed in a positive direction. In this manner, during the V_{H} frame period, the holding period Tₕ has the period T_{d}, in which the voltage Vₚᵢₓ is changed in a negative direction, in the first half and the period Tᵤ, in which the voltage Vₚᵢₓ is changed in a positive direction, in the latter half. Also during the V_{L} frame period, as depicted in FIG. 26B, the voltage Vₚᵢₓ is changed in a negative direction during the first half of the holding period Tₕ, and then is changed in a positive direction. In this manner, also during the V_{L} frame period, the holding period Tₕ has the period T_{d}, in which the voltage Vₚᵢₓ is changed in a negative direction, in the first half and the period Tᵤ, in which the voltage Vₚᵢₓ is changed in a positive direction, in the latter half. Therefore, in the present embodiment, by adjusting the voltages V_{y} and V_{z} of the middle node line MID and adjusting the lengths of the application periods of the voltages V_{y} and V_{z}, the average values of the written voltages V_{w} (the average values of the voltages applied to the liquid crystal element 16) can be equalized in the first half and the latter half of the holding period Tₕ both in the V_{H} frame period and the V_{L} frame period.

In other words, in the present embodiment, the sub-pixels 11 are driven so that the holding period Tₕ in each frame period has a period (T_{d}) in which the voltage of one liquid crystal element 16 falls and a period (Tᵤ) in which the voltage rises. Furthermore, voltages of a plurality of (two) types are applied to a plurality of middle node lines MID so that the average values of voltages applied to the liquid crystal element 16 are equalized in a period (Tₕ₁) in which a voltage of one type (V₁) is applied and a period (Tₕ₂) in which a voltage of another type (V₂) is applied.

With this, luminances of the sub-pixels 11 can be equalized in the period Tₕ₁ and the period Tₕ₂. As a result, flicker can be reduced. Meanwhile, also in the present embodiment, the length of each frame period does not have to be shorter than the length in the past (that is, the frame frequency does not have to be increased). Thus, flicker can be reduced even without driving at high speed. Also, when high-speed driving is not performed, flicker can be reduced, and an increase in power consumption can also be suppressed. Furthermore, with the reduction of flicker, the luminance of the backlight 20 can be increased as ever before. As a result, image quality, such as contrast and luminance, can be increased, while suppressing flicker. Still further, in the present embodiment, since the structure and shape of the sub-pixels 11 are not subjected to any constraint, it is possible to prevent a decrease in the aperture ratio and an increase in the number of masks for use in manufacturing process.

Here, in the present embodiment, irrespectively of whether the types of voltage of the middle node lines MID during the holding period Tₕ are the same for each frame period or not the same during all frame periods, the average voltages of the written voltages V_{w} can be equalized in the Tₕ holding period of the V_{H} frame period and the V_{L} frame period. Also, even when the numbers of voltages of the middle node line MID during the holding period Tₕ are not the same during all frame periods, the average voltages of the written voltages V_{w} can be equalized in the Tₕ holding period of the V_{H} frame period and the V_{L} frame period.

While the embodiments of the present invention have been described above, the present invention is not restricted to the embodiments described above, and can be variously modified. For example, in the embodiments described above, although the voltage to be applied to the common connection line COM and the middle node line MID during the holding period Tₕ is a DC voltage, the voltage may be an AC voltage containing a DC component.

The present application contains subject matter related to that disclosed in Japanese Priority Patent Application JP 2009-154276 filed in the Japan Patent Office on Jun. 29, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display apparatus comprising:
a pixel array section having a plurality of scanning lines disposed in rows, a plurality of signal lines disposed in columns, a plurality of pixel circuits disposed in a matrix correspondingly to intersections of the scanning lines and the signal lines and each connected to a relevant one of the scanning lines and a relevant one of the signal lines corresponding to a relevant one of the intersections, a plurality of liquid crystal elements disposed in a matrix correspondingly to the intersections and each connected to a relevant one of the pixel circuits corresponding to the intersection, and a plurality of common connection lines connected to the plurality of liquid crystal elements for each row; and
a drive circuit section having a scanning line drive circuit sequentially applying a selection pulse to the plurality of scanning lines and sequentially selecting the liquid crystal elements for each of the scanning lines, a signal line drive circuit applying a signal voltage corresponding to a video signal to each of the signal lines so that a polarity is inverted for each frame period and writing in the selected liquid crystal elements, and a common connection line drive circuit applying, during a write period in which writing in the selected liquid crystal elements is being performed, a voltage whose polarity is opposite to a polarity of the signal line to common connection lines corresponding to the selected liquid crystal elements; wherein
the drive circuit section drives each of the pixel circuits so that a holding period in each frame period has a period during which a voltage of one liquid crystal element falls and a period during which the voltage rises.

2. The liquid crystal display apparatus according to claim 1, wherein the common connection line drive circuit applies voltages of a plurality of types to the plurality of common connection lines during a holding period in a predetermined frame period so that the holding period in each frame period has the period during which the voltage of one liquid crystal element falls and the period during which the voltage rises.

3. The liquid crystal display apparatus according to claim 2, wherein a voltage of one of the plurality types is a floating voltage.

4. The liquid crystal display apparatus according to claim 2, wherein, at the beginning of the holding period in the predetermined frame period, the common connection line drive circuit applies to the plurality of common connection lines a voltage equal to a voltage applied, in an AC manner, to the common connection lines corresponding to the selected liquid crystal elements during the write period.

5. The liquid crystal display apparatus according to claim 2, wherein the voltages of the plurality of types are AC voltages including a DC component or DC voltages.

6. The liquid crystal display apparatus according to claim 2, wherein the common connection line drive circuit applies voltages of same types to each desired unit of the plurality of common connection lines during the holding period in the predetermine frame period.

7. The liquid crystal display apparatus according to any one of claims 2 to 6, wherein the common connection line drive circuit applies the voltages of the plurality of types to the plurality of common connection lines so that average values of voltages to be applied to the liquid crystal elements are equal to each other in a period in which a voltage of one type is applied and a period in which a voltage of another type is applied.

8. A liquid crystal display apparatus driving method in a liquid crystal display apparatus including a pixel array section having a plurality of scanning lines disposed in rows, a plurality of signal lines disposed in columns, a plurality of pixel circuits disposed in a matrix correspondingly to intersections of the scanning lines and the signal lines and each connected to a relevant one of the scanning lines and a relevant one of the signal lines corresponding to a relevant one of the intersections, a plurality of liquid crystal elements disposed in a matrix correspondingly to the intersections and each connected to a relevant one of the pixel circuits corresponding to the intersection, and a plurality of common connection lines connected to the plurality of liquid crystal elements for each row; and
a drive circuit section having a scanning line drive circuit sequentially applying a selection pulse to the plurality of scanning lines and sequentially selecting the liquid crystal elements for each of the scanning lines, a signal line drive circuit applying a signal voltage corresponding to a video signal to each of the signal lines so that a polarity is inverted for each frame period and writing in the selected liquid crystal elements, and a common connection line drive circuit applying, during a write period in which writing in the selected liquid crystal element is being performed, a voltage whose polarity is opposite to a polarity of the signal line to common connection lines corresponding to the selected liquid crystal elements,
the method comprising the step of driving each of the pixel circuits by using the drive circuit section so that a holding period in each frame period has a period during which a voltage of one liquid crystal element falls and a period during which the voltage rises.
